(19) United States
(12) Patent Application Publication
(10) Pub. No.: US 2009/0182841 A1
(43) Pub. Date: Jul. 16, 2009

(54) Electronic ad delivery system and method

(76) Inventors: Michael Caruso, Oakland, CA (US); Mikhail Ledvich, Bridgeport, CT (US)

Correspondence Address: DUANE MORRIS LLP - San Diego, 101 WEST BROADWAY, SUITE 900, SAN DIEGO, CA, 92101-8285, US

(21) Appl. No.: 12/008,884

(22) Filed: Jan. 15, 2008

(51) Int. Cl. G06F 15/16; G06Q 30/00

(52) U.S. Cl. 709/218; 705/14

(57) ABSTRACT

A system, method and computer readable medium configured to determine whether an initial electronic advertisement has been displayed, and to deliver an alternate advertisement when the initial electronic advertisement has not been displayed.

### BACKGROUND

1. Field of the Invention

Aspects of the present invention relate in general to electronic/Internet advertising. Specifically, aspects include a method, system, and computer-readable medium configured to determine whether an initial electronic advertisement has been displayed, and to deliver an alternate advertisement when the initial electronic advertisement has not been displayed.

2. Description of the Related Art

In March 1989, the European Laboratory for Particle Physics or CERN (Conseil Europeen pour la Recherche Nucleaire) developed the World-Wide-Web (WWW, or simply, “the web”). The web is an Internet-based computer network that allows users on one computer to access information stored on other computers through a world-wide network. With an intuitive user-interface, known as a “web browser,” the web rapidly became a popular way of transmitting and accessing text and binary information. Since then, there has been a massive expansion in the number of World-Wide-Web sites, and the amount of information placed on the web.

The web is built on a very simple, but powerful premise. All material on the web is formatted in a general, uniform format called HTML (Hypertext Markup Language), and all information requests and responses conform to a similarly standard protocol. When someone accesses a server on the Web, such as the Library of Congress, the user's Web browser will send an information request to the Library of Congress' computer. This computer is called a “web server.” The web server will respond to the request by transmitting the desired information to the user's computer. There, the user's browser will display the received information on the user's screen.

As the World-Wide-Web matures, an increasing amount of web content has evolved from free content to being subsidized by advertising. Such electronic advertisements vary from banner, pop-up, or multi-media ads. Typically, a banner ad is a graphic file embedded in a web-browser page. “Pop-up” ads are advertisements in their own window, separate from the primary web-browser window, and static graphics. Multi-media advertisements may be interactive or other video/audio content delivered via data streaming.

With some web browsers or web-browser plug-ins, users have the option of turning off or blocking advertisements. When advertisements are not delivered, web advertisers may be paying for advertisements unseen by their intended audience; consequently advertisers are less sure whether to buy advertising, and content-providers receive less for their electronic ads.

### SUMMARY

One aspect of the present invention includes the realization that undelivered or unseen advertisements on the Internet are a serious problem. Embodiments of the invention include a system, method and computer readable medium configured to determine whether an initial electronic advertisement has been displayed, and to deliver an alternate advertisement when the initial electronic advertisement has not been displayed.

Embodiments may receive a request for content from the computing-device. An initial advertisement is transmitted to the computing-device. Along with the content being transmitted to the computing-device, the content includes an applet. The applet causes the computing-device to determine whether the computing-device downloaded the initial advertisement. An alternate advertisement is downloaded when the computing-device has not downloaded the initial advertisement.

### BRIEF DESCRIPTION OF THE DRAWINGS

FIG. 1 illustrates an embodiment of a system configured to determine whether an Internet/web advertisement has been displayed, and to deliver an alternate advertisement when an initial Internet advertisement has not been displayed.

FIG. 2 depicts a detailed embodiment of a system configured to track whether a web advertisement has been displayed, and to deliver an alternate advertisement when an initial advertisement has not been displayed.

FIG. 3 is a block diagram of an ad verifier configured to track whether an advertisement has been displayed, and to deliver an alternate advertisement when an initial advertisement has not been displayed.

FIG. 4 is a flowchart of a method embodiment to track whether an advertisement has been displayed, and to deliver an alternate advertisement when an initial advertisement has not been displayed.

### DETAILED DESCRIPTION

One aspect of the present invention includes the realization that the problem of undelivered or unseen advertisements on the Internet limits the amount that publishers can charge; consequently, embodiments of the present invention are configured to determine whether an advertisement has been displayed; when the initial advertisement is not seen by a user, the embodiment attempts to deliver an alternate advertisement. Embodiments also may count and log the number of seen impressions by users.

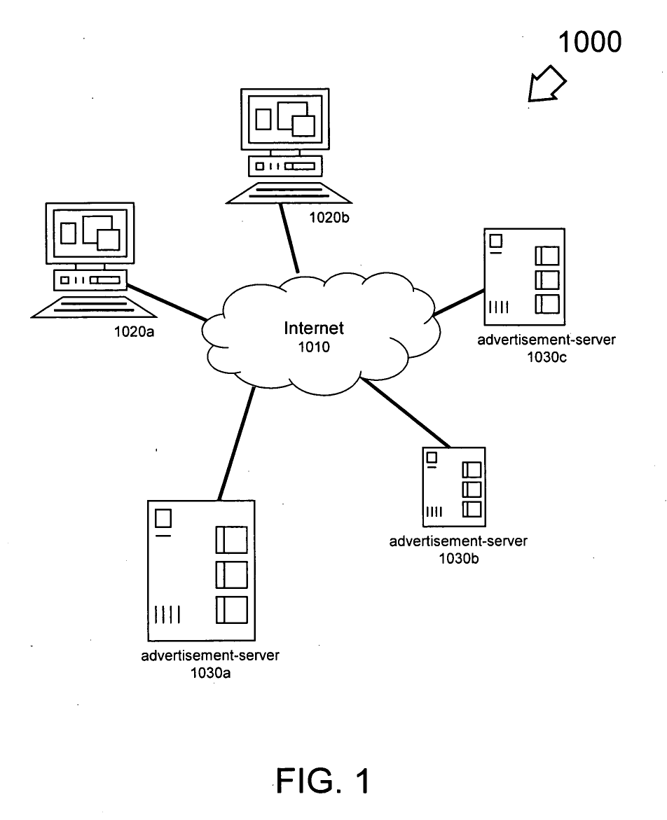

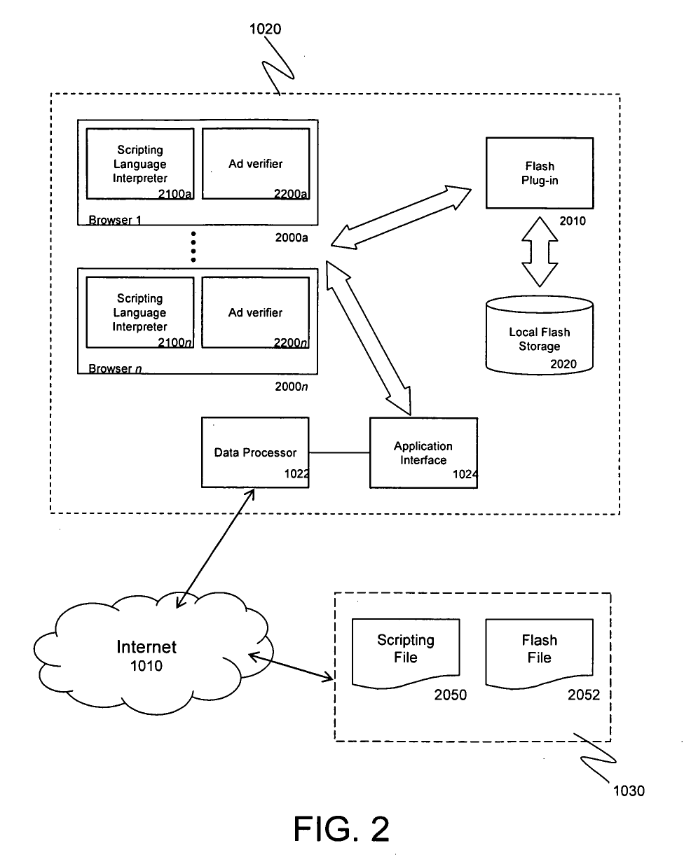

Turning to FIGS. 1 and 2, these figures depict a system 1000 configured to determine whether an advertisement has been displayed; the system attempts to deliver an alternate advertisement when the initial advertisement has been blocked or otherwise not seen by a web-site user.

As shown in FIG. 1, the system 1000 includes a web-user terminals 1020a-b configured to communicate with advertisement servers 1030a-c via a computer network such as the Internet 1010.

For the purposes of this document, web-user terminals 1020 may be any computing device known in the art capable of viewing a web-page or surfing the World-Wide-Web. In some embodiments, web-user terminals 1020 may be enabled with a multi-media flash player. Flash players decode and play back multiple streams of compressed audio and video simultaneously. Examples of flash players include, but are not limited to: Adobe Flash™ (from Adobe Systems Incorporated of San Jose, Calif.), Microsoft Silverlight™ (from Microsoft Corporation of Redmond, Wash.), Gnash (from the Free Software Foundation of Boston, Mass.), and Moonlight (from the Mono Project lead by Novell of Waltham, Mass.).

In some embodiments, web-user terminals 1020 are personal computers connected to a computer network 1010 via a wired connection. In other embodiments, web-user terminals 1020 are wireless mobile devices connected to a computer network 1010 via a WiFi or other wireless network protocol known in the art. Examples include, but are not limited to: notebook computers, personal digital assistants (PDAs), and mobile phones.

Advertisement servers 1030 may be any web-server or computer delivering advertising content. Electronic advertisements come in many different formats. Most typically, advertisements may be text (such as HTML or XML), graphics (GIF, JPEG, or other graphical formats known in the art), or multimedia (such as flash).

Selected internal components of system 1000 are shown in FIG. 2, depicting an expanded version of a web-user terminal 1020 and advertisement-server 1030. Embedded within a processor or central processing unit of web-user terminal 1020, is a data processor 1022, an application interface 1024, and one or more web browsers 2000a-n. Web browsers 2000a-n comprise a scripting language interpreter 2100a-n and an ad verifier 2200a-n. Web browsers 2000a-n have access to flash plug-in 2010 and local flash storage 2020. Some or all of these structures may be stored on a computer-readable medium, as is known in the art.

Data processor 1022 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Data processor 1022 allows web-user terminal 1020 to communicate with advertisement-server 1030.

Application interface 1024 enables web-user terminal 1020 to take some action with respect to a separate software application or entity. For example, application interface 1024 may take the form of a graphical-user or windowing interface, as is commonly known in the art. An example of an application interface includes, but is not limited to: Microsoft Windows, X-Windows, Motif, OpenWindows, and the Apple Macintosh OpenStep user interface.

Web browsers 2000a-n are any software application that enables a user to display and interact with text, images, and other information typically located on a Web page at a website on the World Wide Web or a local area network. Web-browsers include Internet Explorer, Mozilla Firefox, Apple Safari, Opera, and Netscape.

Scripting language interpreter 2100 is any structure that allows web browser 2000 to execute a scripting file 1310 written in a computer scripting language such as Dynamic HTML, Jscript, JavaScript, ECMAScript, Tcl, or VBScript.

As described above, a flash player decodes and plays back multiple streams of compressed audio and video simultaneously. A flash plug-in 2010 is any plug-in, code, program, or applet that enables flash functionality within web browser 2000. Local flash storage 2020 is any local storage accessible by flash plug-in 2010 as storage, including but not limited to persistent identification elements (“PIE”) or local shared object (“LSO” or “.sol”) files.

Advertising server 1030 is any web-site or other server known in the art that serves electronic advertisements. In some embodiments, advertising server 1030 includes scripting file 2050 and flash file 2052.

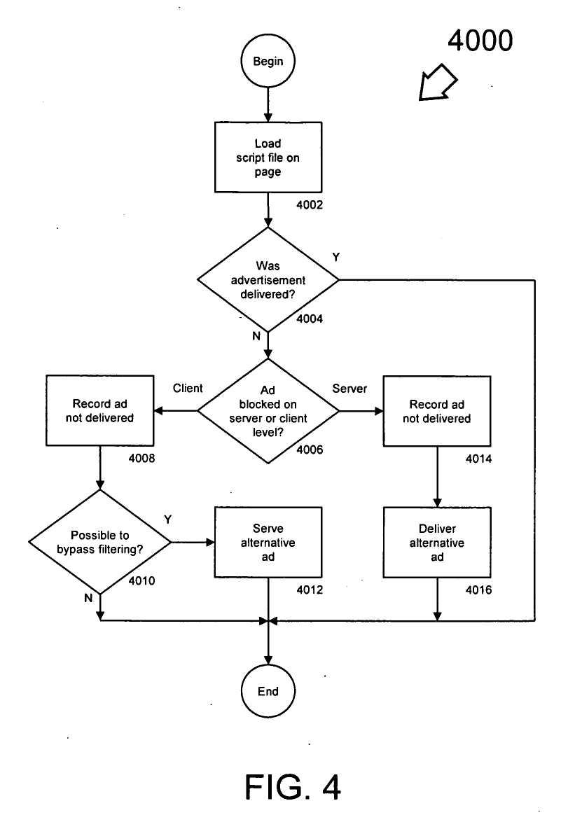

The function of the structures of FIGS. 1 and 2 will best be understood with respect to the flowchart of FIG. 4 described below.

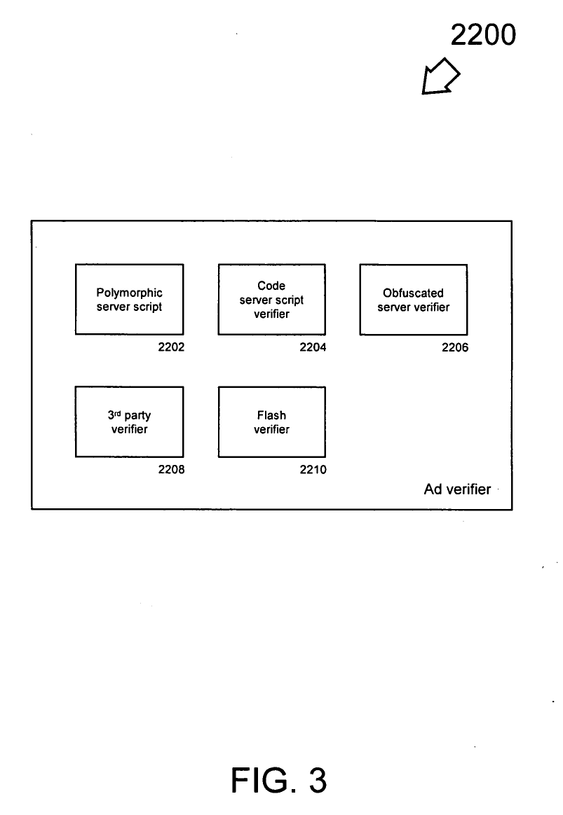

Moving to FIG. 3, the advertisement verifier 2200 is that structure, code, program, script, or plug-in that allows a web-browser to verify whether an advertisement has been displayed; the system attempts to deliver an alternate advertisement when the initial advertisement has been blocked or otherwise not seen by a web-site user. Embodiments also may count and log the number of seen impressions by users.

Embodiments of advertisement verifier 2200 may have some or all of the following sub-components: polymorphic server script 2202, code server script verifier 2204, obfuscated server verifier 2206, 3^{rd} party verifier 2208, or flash verifier 2210. It is understood, by those familiar with the art, that these elements may be written in any client-side computer scripting language known in the art, and may be commonly found written in Dynamic HTML, Jscript, JavaScript, ECMAScript, Tcl, or VBScript.

The function of these structures may best be understood with respect to the flowchart of FIG. 4, as described below.

FIG. 4 illustrates a process embodiment 4000 configured to track whether an advertisement has been displayed; when the initial advertisement has been blocked or otherwise not seen by a web-site user, process 4000 attempts to deliver an alternate advertisement, constructed and operative in accordance with an embodiment of the present invention. The flowchart of FIG. 4 depicts process 4000 from the perspective of web-user terminal 1020. It is understood that by examining FIG. 4, one of ordinary skill in the art would appreciate and understand the same process from the perspective of the advertising server 1030.

Initially process 4000 begins as a user on web-user terminal 1020 surfs to a web-site at advertising-server 1030. It is understood that in some embodiments, advertising-server 1030 merely delivers an advertisement embedded within a web-page delivered by another web-server. When the browser 2000 downloads the web-page, it also loads an initial advertisement and a scripting file 2050, which are embedded within the HTML, block 4002. Once downloaded by browser 2000, scripting file 2050 becomes ad verifier 2200. Scripting file 2050 implements a portion of process 4000. Scripting file may then be executed by browser 2000. Furthermore, scripting file 2050 may contain one or more of the following: polymorphic server script 2202, code server script verifier 2204, obfuscated server verifier 2206, 3^{rd} party verifier 2208, and/or flash verifier 2210.

At decision block 4004, browser 2000 determines whether the initial advertisement has been delivered. In some embodiments, the determination of block 4004 is implemented by a code server script verifier 2204. The determination made at block 4004 may be accomplished by comparing the size of the advertisement downloaded with a predetermined size. If the sizes do not match, the advertisement was not downloaded. It is understood by those familiar with the art, that other comparisons may be used to determine whether the advertisement was delivered. For example, a hashing function and comparison may be used to determine if the advertisement was downloaded.

In embodiments where the web content is not downloaded directly from advertisement-server 1030, the verification of the initial advertisement download may be accomplished by a 3^{rd} party verifier 2208.

If the advertisement was delivered, process 4000 ends.

If the advertisement was not delivered, process flow continues at block 4006.

At block 4006, an server verifier 2006 determines whether the advertisement was blocked on a server or client level. In some embodiments, the server verifier 2006 is hidden (or “obfuscated”) from a web-user's view in a zero-pixel web-frame. When the ad is blocked at the server-level the ad-delivery code is stripped from the page so when the verification code is loaded, it will not find the code to trigger the ad. When an advertisement is blocked on the client level, the ad-trigger code is still loaded by the browser but is never executed.

If the advertisement is blocked at the server level, the polymorphic server script 2202 informs advertisement-server 1030 that the initial advertisement was not delivered, block 4014. An alternate advertisement is delivered at block 4016.

In many embodiments, the alternate ad may be in a different media format than the initial advertisement. This is best illustrated by an example. If the initial advertisement was a static banner ad, such as a JPEG file, the polymorphic server script 2202 attempts to load an alternate flash ad via a flash-plug in 2010. In such an embodiment, the polymorphic server script 2202 instructs the browser 2000 to download a flash file 2052 containing the alternate advertisement. If a flash verifier 2210 detects no flash plug-in 2010 is available, process 400 may revert to downloading another type of alternative ad. Without inventive faculty, those of ordinary skill in the art will readily understand there are numerous other embodiments.

When the advertisement is blocked at the client level, the polymorphic server script 2202 informs advertisement-server 1030 that the initial advertisement was not delivered, block 4008.

At block 4010, polymorphic server script 2202 determines whether it is possible to bypass the client-side filtering. If not, process 4000 ends. If the client-side filtering can be bypassed, the alternate ad is served at 4012.

As discussed earlier, the alternate ad may be in the same or in a different media format than the initial advertisement.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A method of serving advertisements to a computing-device from a web-site comprising:
receiving a request for content from the computing-device;
transmitting an initial advertisement to the computing-device;
transmitting the content to the computing-device, the content including an applet; when executed by the computing-device, the applet causes the computing-device to:
determine whether the computing-device downloaded the initial advertisement; and
download an alternate advertisement when the computing-device has not downloaded the initial advertisement.

2. The method of claim 1, wherein the applet further causes the computing-device to:
transmit a notification to a server when the computing-device has not downloaded the initial advertisement.

3. The method of claim 2, wherein the applet further causes the computing-device to:
determine whether the computing-device has an available flash plug-in; and
wherein the alternate advertisement is a flash advertisement when the computing-device has an available flash plug-in.

4. The method of claim 3, wherein the initial advertisement is either a graphic image or flash-media.

5. The method of claim 4, wherein the applet further causes the computing-device to:
display the alternate advertisement.

6. The method of claim 5, wherein determination of whether the computing-device downloaded the initial advertisement is accomplished through comparing the size of the initial advertisement with a predetermined size.

7. A server configured to deliver advertisements to a computing-device comprising:
means for receiving a request for content from the computing-device;
means for transmitting an initial advertisement to the computing-device;
means for transmitting the content to the computing-device, the content including an applet; when executed by the computing-device, the applet causes the computing-device to:
determine whether the computing-device downloaded the initial advertisement; and
download an alternate advertisement when the computing-device has not downloaded the initial advertisement.

8. The server of claim 7, wherein the applet further causes the computing-device to:
transmit a notification to a server when the computing-device has not downloaded the initial advertisement.

9. The server of claim 8, wherein the applet further causes the computing-device to:
determine whether the computing-device has an available flash plug-in; and
wherein the alternate advertisement is a flash advertisement when the computing-device has an available flash plug-in.

10. The server of claim 9, wherein the initial advertisement is either a graphic image or flash-media.

11. The server of claim 10, wherein the applet further causes the computing-device to:
display the alternate advertisement.

12. The server of claim 11, wherein determination of whether the computing-device downloaded the initial advertisement is accomplished through comparing the size of the initial advertisement with a predetermined size.

13. A method of serving advertisements to a computing-device from a web-site comprising:
determining whether the computing-device downloaded an initial advertisement; and
compelling the computing-device to download an alternate advertisement when the computing-device has not downloaded the initial advertisement.
